(19) United States
(12) Patent Application Publication
(10) Pub. No.: US 2005/0015530 A1
(43) Pub. Date: Jan. 20, 2005

(54) MP3 voice recording/playing device

(76) Inventors: Potter Hsieh, Taipei (TW); Jason Chen, Taipei (TW)

Correspondence Address: Keith Kline;PRO-TECHTOR INTERNATIONAL SERVICES, 20775 Norada Court, Saratoga, CA, 95070-3018, US

(21) Appl. No.: 10/621,748

(22) Filed: Jul. 16, 2003

(51) Int. Cl. G06F 13/12

(52) U.S. Cl. 710/72

(57) ABSTRACT

The present invention provides a MP3 voice recording/playing device. Instead of comprising a memory module, the MP3 voice recording/playing device according to the present invention is connected to an external storage device so as to avoid the complicated process. The user has not to install the driver of the MP3 voice recording/playing device in the computer and has not to connect the MP3 voice recording/playing device to the computer via a transmission line in order to download the music. Therefore, the present invention can greatly reduce the cost and promote the efficiency.

### BACKGROUND OF THE INVENTION

1. Field of the Invention

The present invention relates to a MP3 voice recording/playing device, and particularly, to a MP3 voice recording/playing device to be easily used and operated. Instead of having a memory module, the MP3 voice recording/playing device is connected to an external storage device so as to reduce the cost and simplify the operation. This will avoid the superfluous complicated process, such as installing a driver.

2. Description of the Prior Art

As the technology advances, the society gets more prosperous, and the people's incomings increase, the living quality is promoted while the living pressure is also increased due to various factors. Therefore, it is an important subject to alleviate the living pressure for the people. The pressure can be relieved and the spirit can be inspired and promoted by sporting, traveling, climbing mountain, and listening to the music. In terms of the music, the equipments for music production and playing are greatly improved ad advanced.

The related technologies have been developed, from recording tape, compact disc (CD), video compact disc (VCD), DVD to MP3, having different formats so as to require different playing devices. In all of the mentioned formats, the MP3 music format requires the least storage space, and therefore, the MP3 voice recording/playing device is popular to almost become essential in every family. The MP3 voice recording/playing device is used for playing the music with MP3 formats. However, the conventional MP3 voice recording/playing device has a memory module installed in the device, and when the user wants to download the digitally encoded music format by the computer, the user has to install the driver of the MP3 voice recording/playing device in the computer, and has to use the transmission line to connect the MP3 voice recording/playing device to the computer for downloading.

As mentioned above, the process and operation is so complicated that the user is confused and the cost is promoted. It the original MP3 device is replaced by a new type of MP3 device, the original driver has to be removed from the computer and a new driver has to be installed. In this way, the user has to familiar with the computer, or the user will feel frustrated and confused when operating the MP3 voice recording/playing device. In order to avoid the mention problem, the business is striving for developing the new model.

### SUMMARY OF THE INVENTION

Therefore, the object of the present invention is to provide a MP3 voice recording/playing device. Instead of having a memory module installed inside, the MP3 voice recording/playing device is connected to a portable storage device (such as, a traveling disk) having a USB interface so that the user has not to install the driver of the device making the operation process more ease and simple. By using the storage device having the USB interface, the music with MP3 format will be uploaded and downloaded to/from the computer and the downloaded music will be stored in the storage device having the USB interface. The storage device having the stored music can be connected to the MP3 voice recording/playing device via the USB interface so as to play the music. The user can freely select the capacity of the storage device having the USB interface so as to control the cost and promote the efficiency.

The MP3 voice recording/playing device according to the present invention has the basic structure of the original MP3 voice recording/playing device, and comprises at least one USB interface socket installed in an appropriate position of its body, and a voice source output hole installed in another appropriate position of the its body. The USB interface socket is used for connecting the MP3 voice recording/playing device to the storage device via the USB interface, and the voice source output hole is used for connecting the MP3 voice recording/playing device to the voice output device so as to read and play the music format.

### BRIEF DESCRIPTION OF THE DRAWINGS

The accompanying drawings, which are incorporated in and form part of the specification in which like numerals designate like parts, illustrate preferred embodiments of the present invention and together with the description, serve to explain the principles of the invention. In the drawings:

FIG. 1 is a perspective diagram of a MP3 voice recording/playing device according to the present invention;

FIG. 2 is an exploded view of the MP3 voice recording/playing device according to the present invention;

FIG. 3 is a block diagram of the MP3 voice recording/playing device according to the present invention; and

FIG. 4 is perspective diagram of the MP3 voice recording/playing device connected to a speaker according to the present invention.

### DETAILED DESCRIPTION OF THE PREFERRED EMBODIMENT

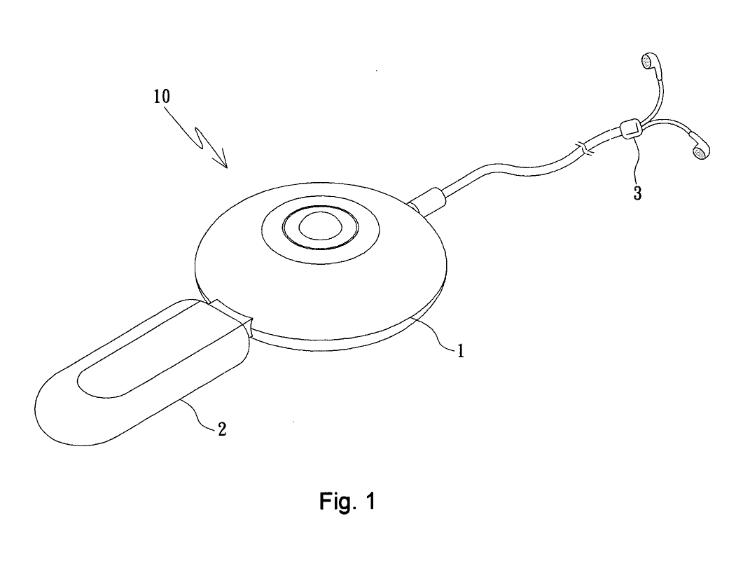

First, please refer to FIG. 1. FIG. 1 is a perspective diagram of a MP3 voice recording/playing device 10 according to the present invention. The MP3 voice recording/playing device 10 is connected to a portable storage device 2 (such as a traveling disk) with USB interface so as to avoid the process of installing the driver of the device 10 and make it easy to operate the device 10. One end of the body 1 of the MP3 voice recording/playing device 10 is connected to the storage device 2 with USB interface, and another end of the body 2 is connected to the voice output device 3 so as to read and play the music format.

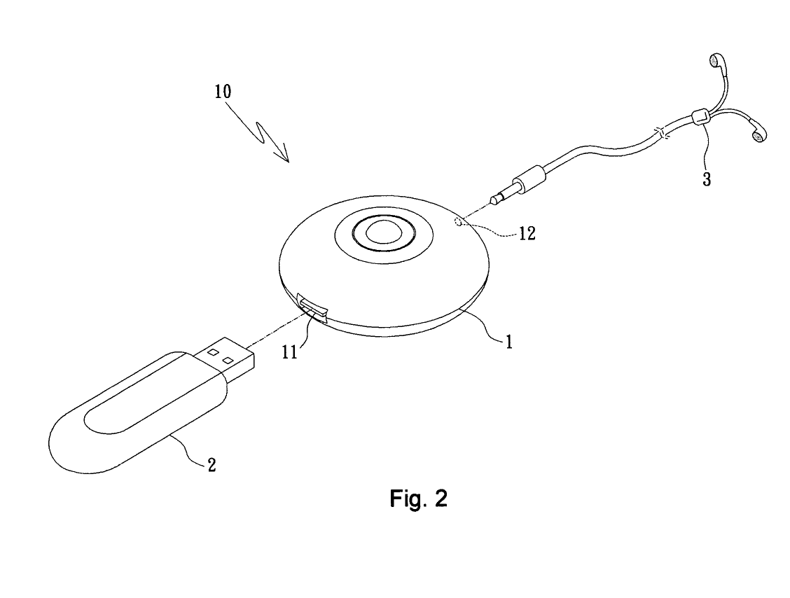

Please refer to FIG. 2. FIG. 2 is an exploded view of the MP3 voice recording/playing device 10 according to the present invention. The MP3 voice recording/playing device 10 has the basic functions of playing, pausing, quick-reviewing, picking-up songs, and tuning. The MP3 voice recording/playing device 10 comprises at least one USB interface socket 11 installed in an appropriate position of its body 1, and a voice source output hole 12 installed in another appropriate position of the its body 1. The USB interface socket 11 is used for connecting the MP3 voice recording/playing device 10 to the storage device 2 via the USB interface, and the voice source output hole 12 is used for connecting the MP3 voice recording/playing device 10 to the voice output device 3 so as to read and play the music format.

The voice output device 3 can be a pair of earphones to be worn on the user's head. The user can easily carry the voice output device 3, the earphones, with him or her, and therefore, the user can listen to the music when moving.

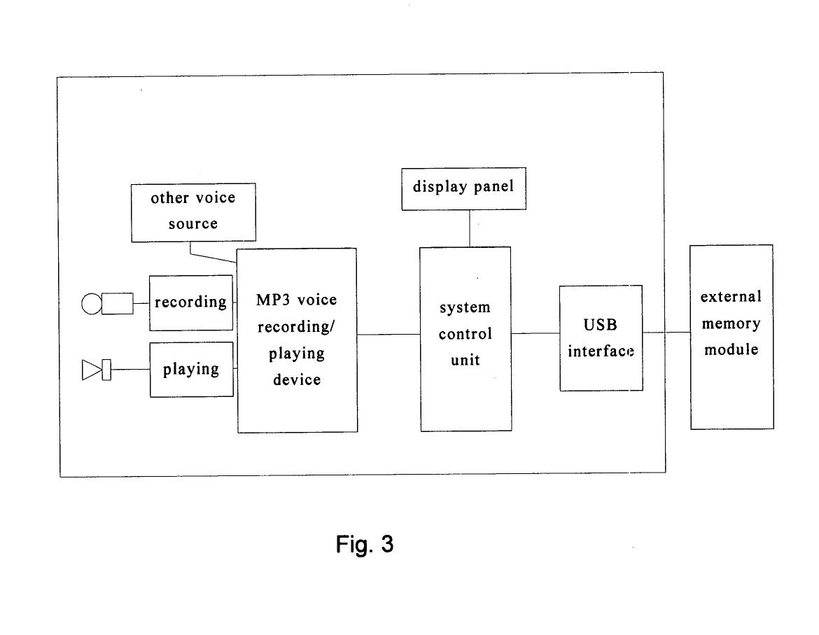

Please refer to FIG. 3. FIG. 3 is a block diagram of the MP3 voice recording/playing device 10 according to the present invention. The MP3 voice recording/playing device 10 comprises a system control unit connected to the USB interface, the display panel and the MP3 recording/playing unit. The MP3 recording/playing unit is connected to another voice source, a recording unit and a playing unit. The mentioned structure is the basic structure of the general MP3 voice recording/playing device. Compared with the prior art, the memory module installed between the system control unit and the MP3 recording/playing unit is removed, and the MP3 voice recording/playing device 10 according to the present invention is connected to an external memory module (such as a traveling disk).

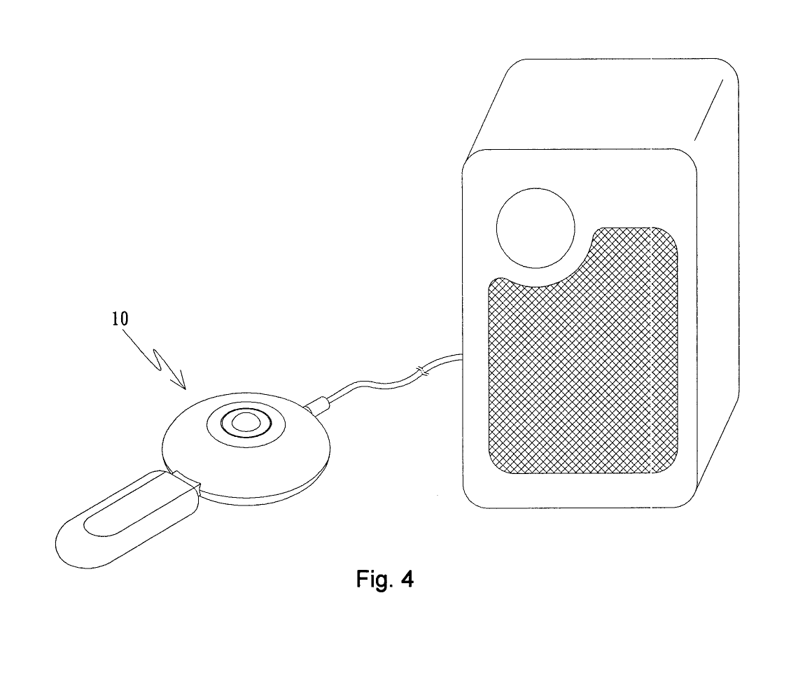

Please refer to FIG. 4. FIG. 4 is perspective diagram of the MP3 voice recording/playing device 10 connected to a speaker according to the present invention. When the user is home or indoor, the user can install the MP3 voice recording/playing device 10 in a fixed position. As shown in FIG. 4, the voice source output hole 12 of the MP3 voice recording/playing device 10 is connected to the voice output device 3. In this embodiment, the voice output device 3 is a speaker.

Those skilled in the art will readily observe that numerous modifications and alterations of the device may be made while retaining the teachings of the invention. Accordingly, the above disclosure should be construed as limited only by the metes and bounds of the appended claims.

1. A MP3 voice recording/playing device connected to a portable storage device via a USB interface and a voice output device so as to read and play music format, wherein the MP3 voice recording/playing device has the basic structure of the original MP3 voice recording/playing device, and comprises:
at least one USB interface socket installed in an appropriate position of its body, and a voice source output hole installed in another appropriate position of the its body;
wherein the USB interface socket is used for connecting the MP3 voice recording/playing device to the storage device via the USB interface, and the voice source output hole is used for connecting the MP3 voice recording/playing device to the voice output device so as to make the operation easy and simplify the structure.

2. The MP3 voice recording/playing device according to the claim 1, wherein the voice output device is a pair of earphones to be worn on the user's head.

3. The MP3 voice recording/playing device according to the claim 1, wherein the voice output device is a speaker.

4. The MP3 voice recording/playing device according to the claim 1, wherein the storage device is a traveling disk.

5. The MP3 voice recording/playing device according to the claim 1, wherein the MP3 voice recording/playing device comprises a system control unit to be connected to the USB interface, a display panel and a MP3 recording/playing unit, and the MP3 recording/playing unit is connected to another voice source, a recording unit and a playing unit.
